(19) United States
(12) Patent Application Publication
(10) Pub. No.: US 2023/0060464 A1
(43) Pub. Date: Mar. 2, 2023

(54) COMPUTER-BASED PLATFORMS/SYSTEMS/DEVICES/COMPONENTS AND/OR OBJECTS CONFIGURED FOR FACILITATING ELECTRONIC CHECK-CASHING TRANSACTIONS AND METHODS OF USE THEREOF

(71) Applicant: Capital One Services, LLC, McLean, VA (US)

(72) Inventors: Ebrima N. Ceesay, McLean, VA (US); Krystan R. Franzen, Mechanicsville, VA (US); Mohamed Seck, Aubrey, TX (US)

(21) Appl. No.: 17/463,132

(22) Filed: Aug. 31, 2021

(51) Int. Cl. G06Q 20/04; G06Q 20/38; G06Q 20/32; G06Q 20/40; G06K 9/00; G06F 11/34

(52) U.S. Cl. CPC G06Q 20/042; G06Q 20/3821; G06Q 20/3274; G06Q 20/3278; G06Q 20/40145; G06K 9/00456; G06F 11/3438

(57) ABSTRACT

In order to enable check-cashing transactions, systems and methods are disclosed including receiving, by a computing device, from an application executed on a mobile device, an activity data for an activity of a user. The computing device receives, from the mobile device, a first user identifying data from the user. The computing device determines a first activity string and a second activity string based on a first activity instruction. The computing device receives a third activity string from an activity-performing device. The computing device performs a second security activity with the third activity string and the first activity string. The computing device instructs the activity-performing device to perform a second activity based on the second security activity and a second activity instruction. The computing device instructs the application executed on the mobile device to modify the activity data entry of the activity based on the second activity instruction.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC., All Rights Reserved.

### FIELD OF TECHNOLOGY

The present disclosure generally relates to computer-based systems configured for authenticating a transaction, and more particularly to computer-based systems for facilitating (e.g., authenticating) check-cashing transactions.

### BACKGROUND OF TECHNOLOGY

Some U.S. households are unbanked and underbanked (i.e., do not have their own bank accounts). Typically, these populations rely on alternative services to meet their financial needs, such as check-cashing and payday loan services to cash their checks at exorbitant costs without utilizing computing devices.

### SUMMARY OF DESCRIBED SUBJECT MATTER

In some embodiments, the present disclosure provides an exemplary technically improved computer-based system/method/apparatus that includes at least the following components/steps of receiving, by a computing device, from an application executed on a mobile computing device, an activity data for an activity of a user; where the activity data comprises an initial activity data; receiving, by the computing device, from the mobile computing device, a first user identifying data from the user; performing, by the computing device, a first security activity with the user identifying data to obtain a secured user identifying data of the user; determining, by the computing device, a first activity instruction based on the secured user identifying data of the user; determining, by the computing device, i) a first activity string and ii) a second activity string based on the first activity instruction; instructing, by the computing device, the application executed on the mobile computing device to display the first activity string to the user; instructing, by the computing device, the application executed on the mobile computing device to generate an activity data entry of the activity; instructing, by the computing device, the application executed on the mobile computing device to modify the activity data entry of the activity with the second activity string; receiving, by the computing device, a third activity string from an activity-performing device; where the first activity string has been received by the activity-performing device from the user; performing, by the computing device, a second security activity with the third activity string and the first activity string; instructing, by the computing device, the activity-performing device to perform a second activity based on the second security activity and a second activity instruction; and instructing, by the computing device, the application executed on the mobile computing device to modify the activity data entry of the activity based on the second activity instruction.

In some embodiments, the present disclosure provides the exemplary technically improved computer-based systems and methods that further include where the initial activity data comprises a check data related to a check provided by the user; and where the check data comprises a check amount of the check and at least one image of the check from an image acquisition software residing on the mobile computing device.

In some embodiments, the present disclosure provides the exemplary technically improved computer-based systems and methods that further include where the first activity instruction comprises an instruction to cash the check.

In some embodiments, the present disclosure provides the exemplary technically improved computer-based systems and methods that further include determining, by the computing device, the check for cashing based on the user being a payee of the check.

In some embodiments, the present disclosure provides the exemplary technically improved computer-based systems and methods that further include transmitting, by the computing device, the first activity string and the second activity string to the application.

In some embodiments, the present disclosure provides the exemplary technically improved computer-based systems and methods that further include where the activity data entry is a check-cashing activity record and the activity performing device is a check-cashing device.

In some embodiments, the present disclosure provides the exemplary technically improved computer-based systems and methods that further include where the first activity string comprises a token; and where the check-cashing device is configured to receive the token is received, from the user, via at least one of: i) a wireless communication between the mobile computing device and the check-cashing device; ii) a QR-code scan by the check-cashing device of a QR-code being displayed by the mobile computing device; and iii) a Near Field communication between the mobile computing device and the check-cashing device.

In some embodiments, the present disclosure provides the exemplary technically improved computer-based systems and methods that further include receiving, by the computing device, at least one biometrical data of the user, wherein the at least one biometrical data of the user comprises at least one of a facial scan, a fingerprint, or both.

In some embodiments, the present disclosure provides the exemplary technically improved computer-based systems and methods that further include where the second activity comprises dispensing a dispensed amount, wherein the dispensed amount is at least a portion of the check amount.

In some embodiments, the present disclosure provides the exemplary technically improved computer-based systems and methods that further include instructing the mobile computing device to present at least one location of at least one activity-performing device.

In some embodiments, the present disclosure provides the exemplary technically improved computer-based systems and methods that include a computing device configured to execute software instructions that cause the computing device to at least: receive, from an application executed on a mobile computing device, an activity data for an activity of a user; where the activity data comprises an initial activity data; receive, from the mobile computing device, a first user identifying data from the user; perform a first security activity with the user identifying data to obtain a secured user identifying data of the user; determine a first activity instruction based on the secured user identifying data of the user; determine i) a first activity string and ii) a second activity string, based on the first activity instruction; instruct the application executed on the mobile computing device to display the first activity string to the user; instruct the application executed on the mobile computing device to generate an activity data entry of the activity; instruct the application executed on the mobile computing device to modify the activity data entry of the activity with the second activity string; receive a third activity string from an activity-performing device; where the first activity string has been received by the activity-performing device from the user; perform a second security activity with the third activity string and the first activity string; instruct the activity-performing device to perform a second activity based on the second security activity and a second activity instruction; and instruct the application executed on the mobile computing device to modify the activity data entry of the activity based on the second activity instruction.

In some embodiments, the present disclosure provides the exemplary technically improved computer-based systems and methods that further include where the initial activity data comprises a check data related to a check provided by the user, wherein the check data comprises a check amount of the check and at least one image of the check from an image acquisition software residing on the mobile computing device.

In some embodiments, the present disclosure provides the exemplary technically improved computer-based systems and methods that further include where the first activity instruction comprises the check for cashing.

In some embodiments, the present disclosure provides the exemplary technically improved computer-based systems and methods that further include the software instructions cause the computing device to determine the check for cashing based on the user being a payee of the check.

In some embodiments, the present disclosure provides the exemplary technically improved computer-based systems and methods that further include where the computing device is further configured to transmit the first activity string and the second activity string to the application.

In some embodiments, the present disclosure provides the exemplary technically improved computer-based systems and methods that further include where the activity data entry is a check-cashing activity record and the activity performing device is a check-cashing device.

In some embodiments, the present disclosure provides the exemplary technically improved computer-based systems and methods that further include where the first activity string comprises a token, where the check-cashing device is configured to receive the token, from the user, via at least one of: i) a wireless communication between the mobile computing device and the check-cashing device; ii) a QR-code scan by the check-cashing device of a QR-code being displayed by the mobile computing device; and iii) a Near Field communication between the mobile computing device and the check-cashing device.

In some embodiments, the present disclosure provides the exemplary technically improved computer-based systems and methods that further include where the computing device is further configured to receive at least one biometrical data of the user, where the at least one biometrical data of the user comprises at least one of a facial scan, a fingerprint, or both.

In some embodiments, the present disclosure provides the exemplary technically improved computer-based systems and methods that further include where the second activity comprises dispensing a dispensed amount, wherein the dispensed amount is at least a portion of the check amount.

In some embodiments, the present disclosure provides the exemplary technically improved computer-based systems and methods that further include where the computing device is further configured to instruct the mobile computing device to present at least one location of at least one activity-performing device.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an operating computer architecture for cashing a check of a user according to one or more embodiments of the disclosure.

FIG. 2 is a process flow diagram illustrating an example of a computer-based process for cashing a check of a user according to one or more embodiments of the disclosure.

FIG. 3 is a process flow diagram illustrating an example of a computer-based process for cashing a check of a user according to one or more embodiments of the disclosure.

FIG. 4 is a process flow diagram illustrating an example of a computer-based process for cashing a check of a user according to one or more embodiments of the disclosure.

FIG. 5 is a process flow diagram illustrating an example of a computer-based process for cashing a check of a user according to one or more embodiments of the disclosure.

FIGS. 6-9 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

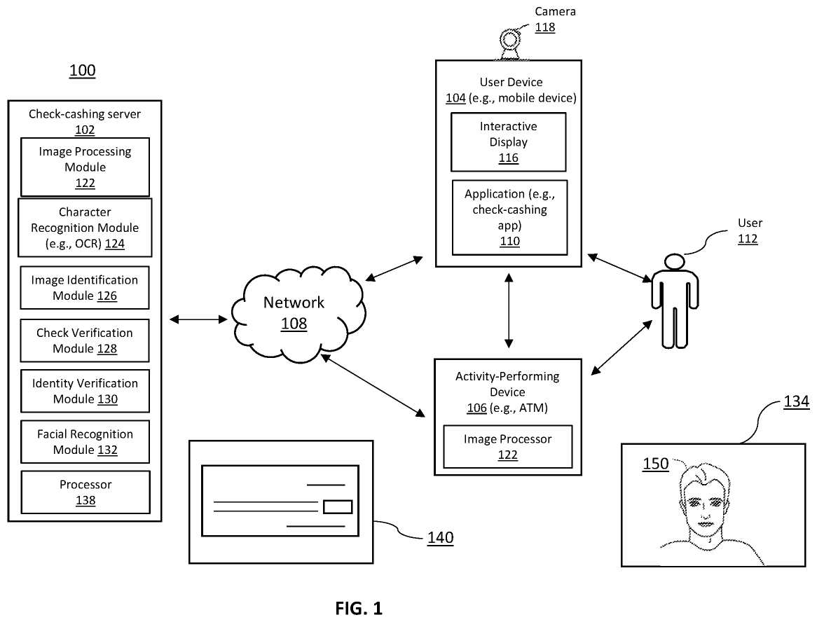

FIGS. 1 through 9 illustrate systems and methods for cashing a check without an associated bank account, via a mobile computing device. The following embodiments provide technical solutions and technical improvements that overcome technical problems, drawbacks and/or deficiencies in the technical fields involving authentication of a check-cashing transaction and data security determinations associated therewith. As explained in more detail, below, the present disclosure provides a technically advantageous computer architecture that improves check-cashing transactions and related fund withdrawals and fund management, in a secure manner, without a bank account at an associated financial entity (e.g., a bank). In certain implementations, an identity verification server or system may be used for verifying the identity of a user in order to permit the user to complete a check-cashing transaction. For example, the identity verification system may use a camera of a mobile computing device to capture an image including a live facial image of a user or a photo ID in order to verify the user's identity to permit cash to be withdrawn at, for example, a financial entity vendor or ATM. As such, implementations consistent with the present disclosure provide a particular, technically advantageous system to reduce the instance of fraud associated with financial transactions and improve security when verifying a user. Some implementations consistent with the present disclosure leverage the wide-spread use of mobile personal communication devices (e.g., smart phones with integrated cameras) to facilitate secure check-cashing users. Based on such technical features, further technical benefits become available to users and operators of these systems and methods. Moreover, various practical applications of the disclosed technology are also described, which provide further practical benefits to users and operators that are also new and useful improvements in the art.

In some embodiments, a financial entity may provide a downloadable software application to the user to install on their mobile computing device, where the software application is designed to prompt the user scan a check the user wishes to cash, and provide a proof-of-identity in the form personally identifying information so as to authenticate the check to be cashed. The application then facilitates check funds management and withdrawal at an activity-performing device (e.g., ATM).

FIG. 1 is a block diagram illustrating an example of an operating computer architecture 100 set up for cashing a check of a user without an associated bank account according to one or more implementations of the disclosure. As shown, the operating computer architecture 100 may include one or more systems including a check-cashing server 102, a user device 104, an activity-performing device (e.g., ATM) 106, and various other systems (not shown) such as additional banking/financial systems, which may interact via a network 108. The network 108 may be any type of wired or wireless network including a local area network (LAN), a wide area network (WAN), or a direct communication link, or other suitable connection.

In some embodiments, the check-cashing server 102 may include hardware components such as a processor 138, which may execute instructions that may reside in local memory and/or transmitted remotely. In some embodiments, the processor 138 may include any type of data processing capacity, such as a hardware logic circuit, for example, an application specific integrated circuit (ASIC) and a programmable logic, or such as a computing device, for example a microcomputer or microcontroller that includes a programmable microprocessor. In some embodiments, the processor 138 may include data-processing capacity provided by the microprocessor. In some embodiments, the microprocessor may include memory, processing, interface resources, controllers, and counters. In some embodiments, the microprocessor may also include one or more programs stored in memory.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

In some embodiments, the user device 104 is a mobile computing device. The user device 104, or mobile user device 104, generally includes computer-readable medium, a processing system, an Input/Output (I/O) subsystem and wireless circuitry. These components may be coupled by one or more communication buses or signal lines. The user device 104 may be any portable electronic device, including a handheld computer, a tablet computer, a mobile phone, laptop computer, tablet device, a multi-function device, a portable gaming device, a vehicle display device, or the like, including a combination of two or more of these items.

It should be apparent that the architecture described is only one example of an architecture for the user device 104, and that user device 104 can have more or fewer components than shown, or a different configuration of components. The various components described above can be implemented in hardware, software, or a combination of both hardware and software, including one or more signal processing and/or application specific integrated circuits.

In some embodiments, the wireless circuitry is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. The wireless circuitry can use various protocols, e.g., as described herein.

The user device 104 may include a check-cashing application 110 (or application software) which may include program code (or a set of instructions) that performs various operations (or methods, functions, processes, etc.) as further described herein. For example, the application may include any type of “app” such as a financial application, etc. In some implementations, the check-cashing application 110 enables users to create a digital wallet which allows the user to withdraw funds, make payments, etc.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the check-cashing application 110 is optional. For example, according to such implementations, the user 112 may be prompted to scan a check to be cashed by an SMS text message, an email, or a web site interface. In accordance with these implementations, the user 112 does not have to install check-cashing application 110 on the user device 104. Rather, the check-cashing server 102 may prompt the user 112 to provide an image 114 of the check and verify the check by prompting the user to provide personal identification information by indicating that a proof-of-identity is needed to complete a cash-checking transaction. The prompt from the check-cashing server 102 may be displayed on interactive display 116 of the user device 104. In this way, the user 112 may be prompted to perform check-cashing verification steps without requiring the user 112 to install or execute the check-cashing application 110 on the user device 104.

In some embodiments, the check-cashing application 110 may be an application usable to manage an existing account of the user. For example, in some embodiments, once the check-cashing application 110 is used to cash a check, an account may be formed for the cashed check funds. In some embodiments, the check-cashing application 110 may be usable to perform online transactions against the balance of the cashed check. According to such embodiments, the check-cashing application 110 may prompt the user for a proof-of-identity in response to the user initiating or requesting certain high-risk or unusual transactions. Such a proof-of-identity prompt may be presented to the user 112 in the interactive display 116 even though the user 112 is already logged into an account using an account ID and password. For instance, the check-cashing application 110 may prompt the user 112 to input a transaction ID in response to the user requesting to withdraw a relatively large amount of funds out of the account.

As shown in FIG. 1, in some embodiments, the user device 104 may be a mobile computing device that includes a camera 118 and an interactive display 116. In some embodiments, the check-cashing application 110 may be a check-cashing application provided by the financial entity. In one implementation, the check-cashing application may be automatically installed onto the user device 104 after being downloaded. In addition, in some embodiments, a check-cashing application or a component thereof (e.g., check verification module 128) may reside (at least partially) on a remote system (e.g., check-cashing server 102) with the various components (e.g., front-end components of the enrollment app) residing on the user device 104. As further described herein, the check-cashing application 110 and the check-cashing server 102 may perform operations (or methods, functions, processes, etc.) that may require access to one or more peripherals and modules. In the example of FIG. 1, the check-cashing server 102 includes an image processing module 122, a character recognition module 124, an image identification module 126, a check verification module 128 and an identity verification module 130.

The image processing module 122 may be implemented as an application (or set of instructions) or software/hardware combination configured to perform operations (or methods, functions, processes, etc.) for receiving and processing images, via the network 108, from the camera 118 of the user device 104. In some embodiments, the images may include front and back images of a check to be cashed by the user. The image processing module 122 may process the image, detect a check using one or more digital image processing techniques, store at least one image of the check, and detect and store portions of the image containing check data (e.g., a check amount, a payee, a signature, an endorsement, a date and a check type). In some embodiments, the image processing module 122 may perform digital image processing operations and/or tasks on the image, such as pattern recognition in order to detect one or more portions of the image that may include the check.

In some embodiments, the image processing module 122 may be also configured to receive and process one or more identifying images of one or more identification documents of the user. For example, in some embodiments, these identifying documents may include a photo-bearing identification documents such as, without limitation, a state identification card, a driver's license, a passport, or other forms of identifying documents such as, without limitation, a birth certificate, a social security card, etc. The image processing module 122 may process one or more identification documents to acquire image(s), detect/recognize identifying data from the acquired image(s) of the one or more identification documents using one or more digital image processing techniques, store the identifying data and/or one or more images of the one or more identification documents, and/or detect and store portions of the identification data (e.g., an associated name, date of birth, address, social security number, driver's license number, passport number, and/or any other data).

In some embodiments, the image processing module 122 may be also configured to receive and process identifying images of the user. For example, in some embodiments, the identifying images may include user live visual input such as, without limitation, one or more live facial image(s) and/or video(s) of the user from the user device 104 and/or an identity document including a photograph of the user. The image processing module 122 may process the user live visual input to detect the user's face using one or more suitable digital image processing techniques, store the user live visual input (e.g., a selfie taken by the user). The image processing module 122 may perform one or more suitable digital image processing operations with the image, such as, without limitation, feature extraction, classification, and/or pattern recognition. One or more of such digital image processing operations may be performed by the image processing module 122 to detect at least one portion of the user live visual input 150 that include the user's face.

In some embodiments, the character recognition module 124 may be implemented as an application (or set of instructions) or software/hardware combination configured to perform operations (or methods, functions, processes, etc.) for recognizing characters present in a particular visual input, such as, without limitation, an image of the check to be cashed or an identification document. The character recognition module 124 may recognize text off the check or identification document as character string(s) and parses those strings to recognize words and numbers in the image. In some embodiments, the character recognition module 124 may be configured to perform optical character recognition (OCR) on the scanned check and/or identity document. In some embodiments, the character recognition module 124 may receive visual image(s) of the check or identity document, recognize character string(s) present in the image(s) and determine characteristics indicated in the character strings (e.g., for a check: check amount, payee, date, address, etc.; for an identification document: date of birth, gender, eye color, etc.).

The image identification module 126 may be implemented as an application (or set of instructions) or software/hardware combination configured to perform operations (or methods, functions, processes, etc.) for processing and recognizing one or more data objects present in an image. In some embodiments, the image identification module 126 may use one or more current computer vision techniques and algorithms to recognize at least one image or other identifier present in a check or an identity document. Such computer vision techniques used by the image identification module 126 may use the results or output of one or more digital image processing operations performed by the image processing module 122. In some embodiments, the computer vision techniques may include performing at least one computer vision task such as, for example, object recognition (e.g., object classification to classify one or more data objects found within the image 140), object identification to identify individual instances of objects (e.g., identifying one or more data objects present in the image 140) and processing image data to detect at least one specific condition (e.g., processing the image 140 to detect the presence of the identity document).

Examples of data objects that may be visible on a check or an identity document include security-feature objects such as, but not limited to, watermarks, line drawings, microprinting, holograms, data-bearing objects such as quick response (QR) codes and bar codes, and the like. Some data-bearing objects included in the data objects may also be used as security features. In some embodiments, the image identification module 126 processes and recognizes one or more data objects, including images such as logos, flags, and official seals (e.g., state or government seals), that are present in the identity document 136. In some embodiments, the image identification module 126 may parse one or more recognized data objects in order to detect whether one or more certain data objects are present in an image of a check or an image of an identity document.

In some embodiments, the check verification module 120 may use such detected data objects and security features to determine if a document is a check and to calculate a document validity score by comparing the recognized characters from the check to data objects and security features present in the check. For example, in some embodiments, the check verification module 120 may determine if one or more security features (e.g., microprinted borders, CPSA padlock, thermal thumbprint, or other identifier) known to be present on checks are found in the recognized characters and objects of the user's check.

Similarly, the identity verification module 130 may use such detected data objects and security features to determine a type of the identity document and to calculate a document validity score by comparing the recognized characters from the user's identity document to one or more data objects and security features present in the identified type of the identity document 136. For example, if the type of the identity document is determined to be a driver's license issued by a certain state, the identity verification module 130 may determine if one or more security features (e.g., a watermark with the state seal, flag, or other identifier) known to be present in that state's driver's licenses are found in the recognized characters and objects of the user's identity document.

The facial recognition module 132 may be implemented as an application (or set of instructions) or software/hardware combination configured to perform operations (or methods, functions, processes, etc.) for performing facial recognition in order to verify that the live facial image (e.g., selfie) is an image of the same individual depicted in the photograph from the identity document. In some embodiments, he facial recognition module 132 may use one or more current facial recognition techniques and algorithms that extract facial information (e.g., facial signature data) from an image, compare it to facial information extracted from another image, and determine a probability that represents whether the two images are of the same person. In example embodiments, the facial recognition module 132 may use one or more facial recognition techniques and algorithms such as, for instance, intrinsic face movement, depth mapping algorithms, neural networks, 3D sensing techniques, and texture detection. Such facial recognition techniques and algorithms can recognize and identify a particular individual in the live facial image and determine whether that individual is the same individual that is depicted in the photograph in the identity document. In one example, the facial recognition module 132 may extract facial features (e.g., facial signature data) from the live facial image 134 and from the photograph in the identity document photograph. In an example embodiment, the facial recognition module 132 may calculate a facial match score by comparing one or more facial features extracted from the live facial image to one or more facial features extracted from the photograph. In another example embodiment, the facial recognition module 132 could translate both the live facial image 134 (e.g., the selfie) and the photograph from the identity document 136 into respective topographical maps, scale the two topographical maps to be the same size, overlay the maps on top of each other, and compare the severity of differences between the maps.

The identity verification module 130 may be implemented as an application (or set of instructions) or software/hardware combination configured to perform one or more operations (or methods, functions, processes, etc.) for verifying the identity of the user depicted in the live facial image.

For example, the identity verification module 130 may compare the document validity score to a predetermined, tunable, document validity threshold to determine whether the identity document is valid or not. In certain embodiments, the document validity threshold may be tuned by one or more manual adjustments (e.g., settings selected by a system administrator). In additional or alternative embodiments, machine learning may be used to automatically adjust the document validity threshold over time. For example, the identity verification module 130 may train a machine learning model to automatically adjust the document validity threshold. In certain implementations, the document validity threshold may be adjusted manually. For instance, to account for certain machine learning models that may have the risk of teaching themselves incorrectly, in some implementations, the operating computer architecture 100 may be programmed to allow for one or more manual corrections and adjustments to the document validity threshold. For example, to account for an incorrectly trained machine learning model that sets the document validity threshold too high, which results in misidentifying legitimate identity documents as being fakes or forgeries, such implementations allow a system administrator to manually reduce the document validity threshold. The document validity score may be determined in part by comparing one or more recognized characters that have been translated into meaningful values (e.g., secondary characteristics such as name, address, height, weight, date of birth and the like), and/or one or more objects found in the user's identity document to one or more data objects and/or security features (e.g., watermarks, holograms, etc.) known to be present in that type of identity document (e.g., a driver's license, passport, etc.). In some implementations, the identity verification module 130 may check to see if the user is in a database (e.g., a black list or a grey list) of known identities that have been have compromised (e.g., stolen IDs) and/or that have been banned from financial activities (e.g., anti-money laundering). Such a database may be remote from or included in the previously collected data. In some embodiments, the identity verification module 130 may be programmed to perform KYC (“know-your-customer”) and/or AML (“anti-money laundering”) verification analysis. In some embodiments, the exemplary KYC determination(s) of the present disclosure with associated devices are configured to, for example without limitation, to prevent money laundering transactions (anti-money laundering (AML) enforcement) and/or fraudulent transactions.

For example, one or more entities can be managed by one or more financial institutions (e.g., banks) who may have pre-determined KYC procedures based at least in part on AML rules and/or database(s) of suspicious activities, accounts, individuals, and companies—KYC/AML procedure(s). In some embodiments, exemplary KYC/AML procedure(s) are programmed to enforce compliance with anti-bribery and corruption regulations, including Title 18, USC 1956, Title 18, USC 1957, Title 18, USC 1960, Bank Secrecy Act, Anti-Money Laundering Act, Counter Terrorist Financing Act, Know Your Customer Act, The Patriot Act, Foreign Corrupt Practices Act (FCPA), Customer Information Program (CIP), similar laws/regulations and the like.

In some embodiments, the identity verification module 130 may compare the facial match score calculated by the facial recognition module 132 to a predetermined, tunable, facial match threshold to determine a confidence level representing whether the individual in the live facial image is the same person depicted in the photograph in the identity document. In some implementations, the document validity score and the facial match scores may be expressed as numeric values (e.g., percentages or numbers indicating a confidence level that the identity document is valid, and the person depicted in the live facial image and the photograph is the same individual). For example, a 75% facial match score may indicate that 75% of the distinguishing facial characteristics detected in the live facial image and in the photograph match. By using sets of training data of facial image pairs to train a machine learning model, the identity verification results over time.

When performing operations, the user device 104 may interact with the check-cashing server 102 to, for example, instruct to install the check-cashing application 110 (e.g., enrollment application) on the user device 104. For example, the check-cashing server 102 may receive a transaction request from the user device 104. For example, the transaction request may include a request to automatically perform at least one financial service/transaction (e.g., paying an utility bill) based at least in part on at least a portion of the amount of the check.

In some embodiments, the activity-performing device 106 is remote from the check-cashing server 102 (e.g., a separate system accessed via the network 108) and associated with the third-party providing the check-cashing application 110. In some embodiments, the activity-performing device 106 may be a kiosk, ATM, wall-mounted device, or table-mounted device associated (e.g., maintained by, provided by, owned by, etc.) with a financial entity.

In some embodiments, the check-cashing server 102 may be associated (e.g., maintained by, provided by, owned by, etc.) with the third-party. As described, the check-cashing service provided by the check-cashing server 102 may have a corresponding check-cashing application 110 (e.g., corresponding application available on an application store for various platforms) that is installed on the user device 104.

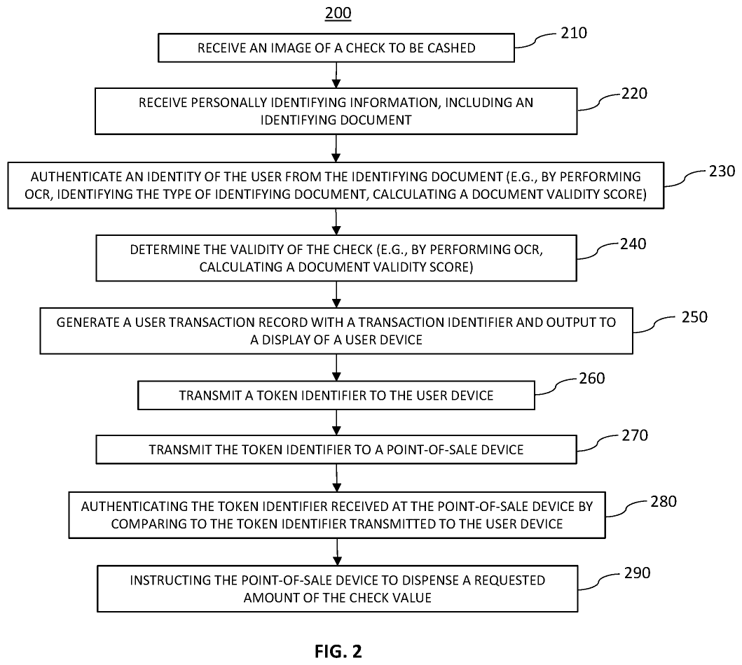

FIG. 2 is a process flow diagram illustrating an example of an illustrative computer-mediated process for cashing a check of a user according to one or more embodiments of the disclosure. The exemplary computer-mediated process 200 may use executed by software, hardware, or a combination thereof. For example, process 200 may be performed by including one or more components described in the operating computer architecture 100 of FIG. 1 (e.g., check-cashing server 102, user device 104 and activity-performing device 106).

In 210, the exemplary computer-based system (e.g., s the check-cashing server 102) may receive an image (e.g., an image 140) of a check of a user 112 to be cashed. In some embodiments, the image may be captured by a camera of a user device 104 and transmitted via network 108. In some embodiments, the image capture may be performed by the check-cashing application 110 available to all users of the user device 104. In some embodiments, the image capture may be performed by a conventional camera application that comes with a mobile phone user device 104, and the resulting image may be uploaded by a conventional browser that comes with the mobile phone to the check cashing server 102 via a website/web interface of the check cashing server 102. In such implementation, the phone would not need the check-cashing application 110 to be installed on it. Instead, the mobile phone user device 104 may just use its native capabilities.

In 220, in response to the receiving of the image of the check to be cashed, the check cashing server 102 may prompt the user, via the check-cashing application 110 to input personally identifying information (PII). In some embodiments, the PII may include general personal information about the user such as, for example, name, date of birth, address, etc. In some embodiments, the PII may include information from, or a photo of, identification documents such as, for example, a government-issued ID, a driver's license, a passport, etc. In some embodiments, the PII may include biometrical data including, for example, a live facial image or a fingerprint.

For example, at 220, the check-cashing application 110 may prompt the user to first input general personal information and then provide an image of at least one identification document. In this embodiment, the user may manually enter the general personal information, which is transmitted via the network 108. An image of the identification document may then be captured by a camera of the user device 104 and transmitted via the network 108.

At 230, the system may authenticate the identity of the user by verifying the identification document. In the example of FIG. 2, 230 may comprise performing OCR. In some embodiments, such character recognition may be performed by the character recognition module 124. In an embodiment, 230 may also comprise recognizing data objects such as character strings and graphical images present in the identity document. At 230, the system may use computer vision techniques to recognize data objects in addition to characters to detect security features present in the identity document. In some implementations, the recognized data objects include one or more of: a watermark; a hologram; a bar code; a serial number; a thumbnail version of the photograph; a negative image of the photograph; and a QR code. In some implementations, such object recognition may be performed by the image identification module 126.

In some embodiments, the system may identify, by parsing the recognized characters and/or analyzing the data objects, a type of the identity document. For example, the system may determine that the identity document is a US passport based on the presence, form, and/or location of a hologram and watermark detected in the identity document. In some implementations, the parsed characters and detected data objects are compared to known identity document formats or configurations, such as predetermined character strings, data objects, and security features that are known to be present e.g., at specific locations, in specific types of identity documents (e.g., photo ID such as a driver's license, or ID cards issued by certain states or jurisdictions).

In some embodiments, the system may then calculate a document validity score by comparing the recognized characters and data objects to security features known to be present in the identified type of the identity document. For example, 230 may comprise calculating the document validity score as a percentage of data objects recognized or identified from the identity document, which has been determined to be a California driver's license, with respect to the entire set of data objects (e.g., identifiers, logos, seals images, data-bearing objects, and security features) known to be present in California driver's licenses.

The user's identity may be verified based at least in part on recognizing a name from the identity document using OCR and verifying that the recognized name corresponds to a name associated with the name input by the user. For instance, the check-cashing server 102 may access previously collected user information for a particular user to assist in verifying that user's identity. Based on the above, the system may then authenticate the identity of the user.

At step 240, the system may determine the validity of the check. Specifically, the image processing module 122 may be used to provide probabilities that the check data matches the PII provided by the client. In some embodiments, the system may recognize characters in the check to be cashed. In the example of FIG. 2, step 240 may comprise performing OCR. In some embodiments, such character recognition may be performed by the character recognition module 124.

In an embodiment, step 240 may also comprise recognizing data objects such as character strings and graphical images present in the check. At 240, the system may use computer vision techniques to recognize data objects in addition to characters to detect security features present in the check. For example, in some embodiments, the check verification module 120 may use such detected data objects and security features to calculate a document validity score by comparing the recognized characters from the check to data objects and security features present in the check. For example, the check verification module 120 may determine if security features (e.g., microprinted borders, CPSA padlock, thermal thumbprint, or other identifier) known to be present on checks are found in the recognized characters and objects of the user's check. For example, 240 may comprise calculating the document validity score as a percentage of data objects recognized or identified from the check with respect to the entire set of data objects known to be present in different types of checks (e.g., personal check, cashier's check, etc.). In some embodiments, the check may be valid only if the user is the same as the payee of the check. Based on the above, the system may then identify and authenticate the check for cashing by the user.

At step 250, once the check is authenticated, the system may generate a user transaction record with a first check-cashing activity string. In some embodiments, the first check-cashing activity string may be a transaction identifier or transaction reference number. In some embodiments, the user transaction record may be a virtual wallet. In some embodiments, the system generates a check-cashing activity record associated with the user transaction record, which may be displayed to the user by the check-cashing application 110 on the user device 104. The user may be able to access the virtual wallet and the check-cashing activity record by logging into the check-cashing application 110. The check-cashing activity record may be updated, in real-time, based on transaction activities performed by the user, such as withdrawal of funds from the user transaction record.

At step 260, the system may generate a second check-cashing activity string that may be used to verify the user at the time of fund withdrawal from the user transaction record. For example, in some embodiments, the second check-cashing activity string may be a token identifier which can be submitted at a point-of-sale (POS), such as an ATM, to authenticate the user's identity at the time of withdrawal of funds, as will be described in further detail below. In some embodiments, the system may transmit the token identifier to the check-cashing application 110 on the user's device 104. In some embodiments, the token identifier may be displayed to the user on the interactive display 116. In some embodiments, the token identifier may be displayed as a personal identification number (PIN) or a QR-code that may be scannable at the POS device.

At step 270, the system transmits the token identifier to a POS device, identified by the user, as a location at which the user wishes to withdraw at least a portion of the check funds. In some embodiments, the POS device may be an activity-performing device, such as an ATM. In other embodiments, the POS device may be at a kiosk or vendor at a bank location.

At step 280, the user inputs the token identifier at the POS device to verify the user's identity. In some embodiments, POS device may be configured to receive the token identifier by a wireless communication between the user device 104 and the POS device. In other embodiments, the POS includes an image processor that scans the QR code provided on the user device 104. In other embodiments, the token identifier may be transmitted to the POS device by a Near Field communication between the user device 104 and the POS device. The system verifies the user's identify by comparing the token identifier provided to the user on the user's device 104 with the token identifier input at the POS device. If the token identifiers match, the user's identity is verified.

At step 290, if the token identifier input to the POS device matches the token identifier provided to the user device 104, the activity-performing device may be instructed to dispense a requested amount of the cashed check value. In some embodiments, the requested amount of the cashed check value may be less than the full cashed check value. In some embodiments, the check-cashing activity record may be updated to reflect the new balance of cashed check value, after the requested amount of the cashed check value may be dispensed. In some embodiments, the system provides the new balance to a display device (e.g., the interactive display 116 of the user device 104).

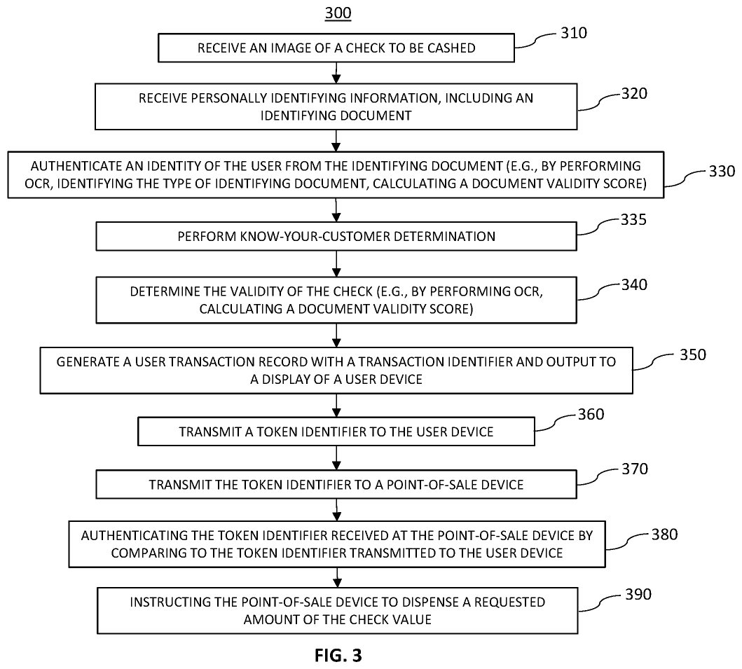

FIG. 3 is a process flow diagram illustrating an example of another process for cashing a check of a user according to one or more embodiments of the disclosure. Process 300 may use processing logic, which may include software, hardware, or a combination thereof. For example, process 300 may be performed by a system including one or more components described in operating computer architecture 100 (e.g., check-cashing server 102 and user device 104).

In some embodiments, the process 300 is the same as process 200, with all of the same steps provided above with respect to process 200, but includes a further step 335, in which a KYC verification analysis may be performed to further verify the identity of the user.

In some embodiments, a user transaction record may include any combination of identification document data such as an associated name, date of birth, address, social security number, driver's license number, passport number, and/or any other data from an identification document associated with the record.

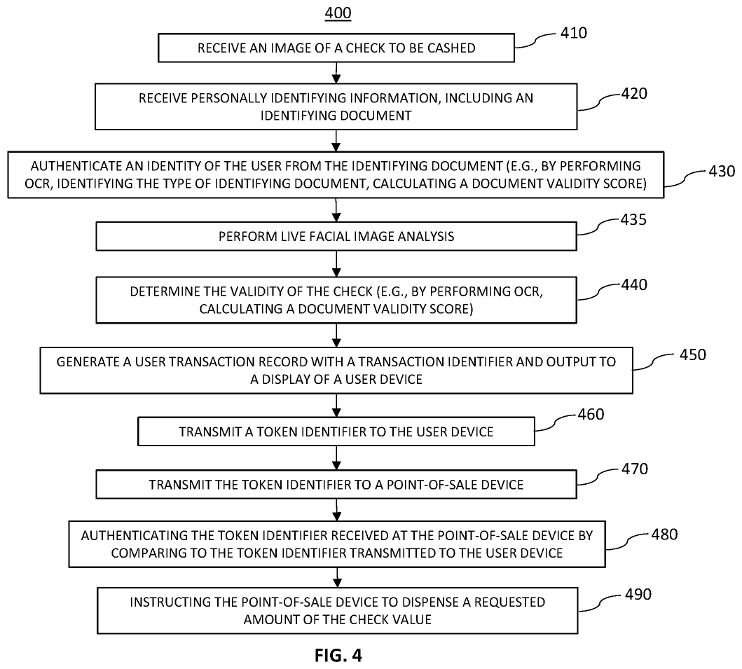

FIG. 4 is a process flow diagram illustrating an example of another process for cashing a check of a user according to one or more embodiments of the disclosure. Process 400 may use processing logic, which may include software, hardware, or a combination thereof. For example, process 400 may be performed by a system including one or more components described in operating computer architecture 100 (e.g., check-cashing server 102 and user device 104).

In some embodiments, the process 400 is the same as process 200, with all of the same steps provided above with respect to process 200, but includes a further step 435 in which a live facial image analysis may be performed further verify the identity of the user.

In the example of FIG. 4, step 435 may comprise receiving a selfie taken by a user by the image processing module 122. The system may calculate a facial match score by comparing facial features in the live facial image to facial features in a photograph on a photo ID (identity document). In the example of FIG. 4, step 435 may comprise performing facial recognition. For example, the system may use the image captured by the camera 118 to perform the facial recognition and verify or determine a likelihood or probability that the person shown in the live facial image is the same person as is shown in the photo ID. In certain implementations, step 435 may be performed by the facial recognition module 132.

In some embodiments, the system may determine, based on comparing the facial match score to a predetermined facial match threshold and comparing the document validity score to a predetermined document validity threshold, an identity verification status of the user. The thresholds may be numeric values (e.g., percentages) that must be met before the system deems the identity document to be valid and the facial images (in the live facial image and photograph) to be a match. For example, the facial match threshold may be a percentage ranging from about 60% to 100%, such as 65%, 70%, 75%, or 80%, and the document validity threshold may be a percentage ranging from about 70% to 100%, such as 75%, 80%, 85%, or 90% In certain embodiments, step 435 may include a feedback loop whereby the user may be prompted when the facial match threshold is not met. For instance, if a confidence level representing whether the individual in the live facial image may be the same person depicted in the photograph in the identity document is too low (e.g., below the facial match threshold), step 435 may include prompting the user via the interactive display 116 to provide more data (e.g., “Re-take selfie,” “Take a close-up,” or the like) or alter the conditions (e.g., “turn on the lights,” “turn off flash”, “take off your sunglasses”, or the like).

In addition, in 435, the user's identity may be verified based at least in part on a combination of facial recognition as well as OCR from the identity document (e.g., ID card) to verify that the face of the user in the selfie matches the face shown in the photograph on the identity document. The system may output the identity verification status. In the example of FIG. 4, step 435 may comprise providing the status to a display device (e.g., the interactive display 116 of the user device 104).

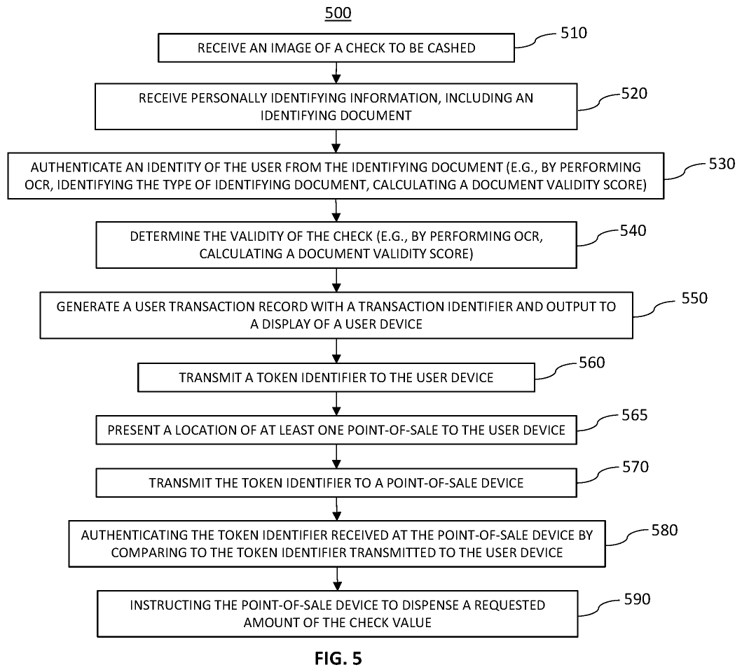

FIG. 5 is a process flow diagram illustrating an example of another process for cashing a check of a user according to one or more embodiments of the disclosure. Process 500 may use processing logic, which may include software, hardware, or a combination thereof. For example, process 500 may be performed by a system including one or more components described in operating computer architecture 100 (e.g., check-cashing server 102 and user device 104).

In some embodiments, the process 500 is the same as process 200, with all of the same steps provided above with respect to process 200, but includes a further step 565, in which the system instructs the user device 104 to present at least one location of at least one POS device.

In some embodiments, the mobile device 104 can include a GPS receiver, sometimes referred to as a GPS unit. A mobile device can use a satellite navigation, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimates, the mobile device can determine a location fix, altitude, and/or current speed. A location fix can be geographical coordinates such as latitudinal and longitudinal information.

In some embodiments, the mobile device 104 uses GPS to determine the location of POS device (e.g., ATMs and bank vendors) associated with the financial institute of the check-cashing application 110. In some embodiments, step 565 comprises providing a list of POS device locations to a display device (e.g., the interactive display 116 of the user device 104).

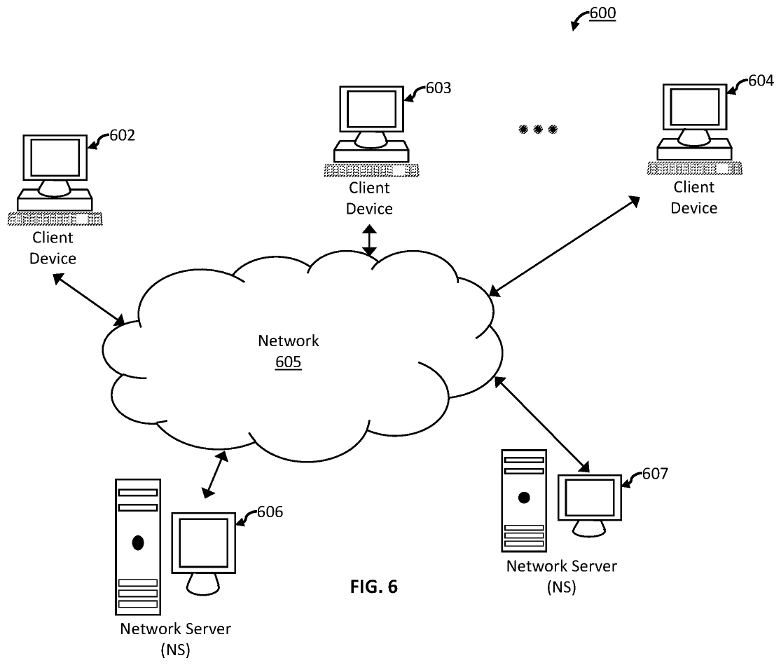

FIG. 6 depicts a block diagram of an exemplary computer-based system and platform 600 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 600 may be configured to manage a large number of members and concurrent transactions, as detailed herein. In some embodiments, the exemplary computer-based system and platform 600 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 6, member computing device 602, member computing device 603 through member computing device 604 (e.g., clients) of the exemplary computer-based system and platform 600 may include virtually any computing device capable of receiving and sending a message over a network (e.g., cloud network), such as network 605, to and from another computing device, such as servers 606 and 607, each other, and the like. In some embodiments, the member devices 602-604 may be personal computers, multiprocessor systems, microprocessor-based or programmable consumer electronics, network PCs, and the like. In some embodiments, one or more member devices within member devices 602-604 may include computing devices that typically connect using a wireless communications medium such as cell phones, smart phones, pagers, walkie talkies, radio frequency (RF) devices, infrared (IR) devices, GB-s citizens band radio, integrated devices combining one or more of the preceding devices, or virtually any mobile computing device, and the like. In some embodiments, one or more member devices within member devices 602-604 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 602-604 may include may run one or more applications, such as Internet browsers, mobile applications, voice calls, video games, videoconferencing, and email, among others. In some embodiments, one or more member devices within member devices 602-604 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 602-604 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 602-604 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 605 may provide network access, data transport and/or other services to any computing device coupled to it. In some embodiments, the exemplary network 605 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 605 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 605 may include and implement, as an alternative or in conjunction with one or more of the above, a WiMAX architecture defined by the WiMAX forum. In some embodiments and, optionally, in combination of any embodiment described above or below, the exemplary network 605 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 605 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 605 may also include mass storage, such as network attached storage (NAS), a storage area network (SAN), a content delivery network (CDN) or other forms of computer or machine readable media.

In some embodiments, the exemplary server 606 or the exemplary server 607 may be a web server (or a series of servers) running a network operating system, examples of which may include but are not limited to Apache on Linux or Microsoft IIS (Internet Information Services). In some embodiments, the exemplary server 606 or the exemplary server 607 may be used for and/or provide cloud and/or network computing. Although not shown in FIG. 6, in some embodiments, the exemplary server 606 or the exemplary server 607 may have connections to external systems like email, SMS messaging, text messaging, ad content providers, etc. Any of the features of the exemplary server 606 may be also implemented in the exemplary server 607 and vice versa.

In some embodiments, one or more of the exemplary servers 606 and 607 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 601-604.

In some embodiments and, optionally, in combination of any embodiment described above or below, for example, one or more exemplary computing member devices 602-604, the exemplary server 606, and/or the exemplary server 607 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

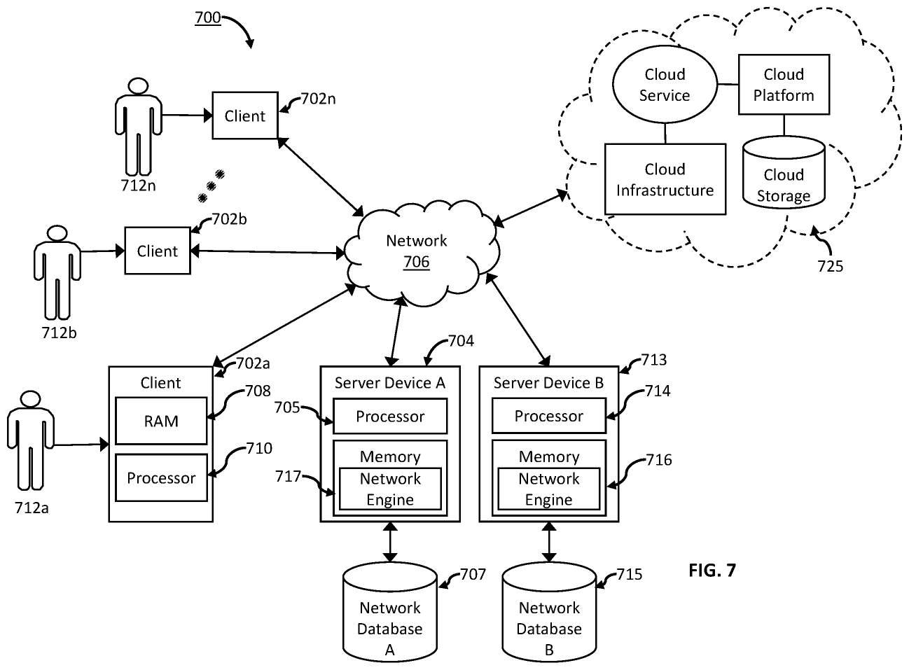

FIG. 7 depicts a block diagram of another exemplary computer-based system and platform 700 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 702a, member computing device 702b through member computing device 702n shown each at least includes a computer-readable medium, such as a random-access memory (RAM) 708 coupled to a processor 710 or FLASH memory. In some embodiments, the processor 710 may execute computer-executable program instructions stored in memory 708. In some embodiments, the processor 710 may include a microprocessor, an ASIC, and/or a state machine. In some embodiments, the processor 710 may include, or may be in communication with, media, for example computer-readable media, which stores instructions that, when executed by the processor 710, may cause the processor 710 to perform one or more steps described herein. In some embodiments, examples of computer-readable media may include, but are not limited to, an electronic, optical, magnetic, or other storage or transmission device capable of providing a processor, such as the processor 710 of client 702a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 702a through 702n may also comprise a number of external or internal devices such as a mouse, a CD-ROM, DVD, a physical or virtual keyboard, a display, or other input or output devices. In some embodiments, examples of member computing devices 702a through 702n (e.g., clients) may be any type of processor-based platforms that are connected to a network 706 such as, without limitation, personal computers, digital assistants, personal digital assistants, smart phones, pagers, digital tablets, laptop computers, Internet appliances, and other processor-based devices. In some embodiments, member computing devices 702a through 702n may be specifically programmed with one or more application programs in accordance with one or more principles/methodologies detailed herein. In some embodiments, member computing devices 702a through 702n may operate on any operating system capable of supporting a browser or browser-enabled application, such as Microsoft™ Windows™, and/or Linux. In some embodiments, member computing devices 702a through 702n shown may include, for example, personal computers executing a browser application program such as Microsoft Corporation's Internet Explorer™, Apple Computer, Inc.'s Safari™, Mozilla Firefox, and/or Opera. In some embodiments, through the member computing user devices 702a through 702n, user 712a, user 712b through user 712n, may communicate over the exemplary network 706 with each other and/or with other systems and/or devices coupled to the network 706. As shown in FIG. 7, exemplary server devices 704 and 713 may include processor 705 and processor 714, respectively, as well as memory 717 and memory 716, respectively. In some embodiments, the server devices 704 and 713 may be also coupled to the network 706. In some embodiments, one or more member computing devices 702a through 702n may be mobile clients.

In some embodiments, at least one database of exemplary databases 707 and 715 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

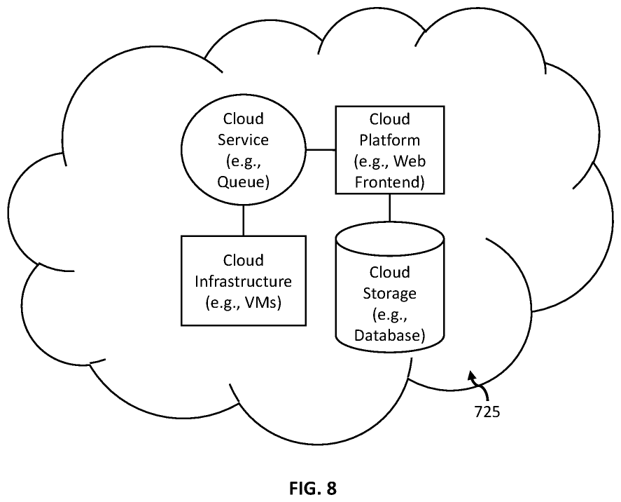

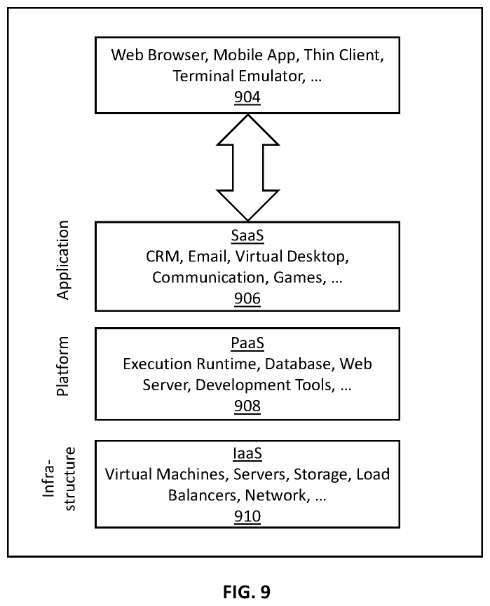

In some embodiments, the exemplary inventive computer-based systems/platforms, the exemplary inventive computer-based devices, and/or the exemplary inventive computer-based components of the present disclosure may be specifically configured to operate in a cloud computing/architecture 725 such as, but not limiting to: infrastructure a service (IaaS) 910, platform as a service (PaaS) 908, and/or software as a service (SaaS) 906 using a web browser, mobile app, thin client, terminal emulator or other endpoint 904. FIGS. 8 and 9 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

1. A method comprising:

receiving, by a computing device, from an application executed on a mobile computing device, an activity data for an activity of a user;
wherein the activity data comprises an initial activity data;

receiving, by the computing device, from the mobile computing device, a first user identifying data from the user;

performing, by the computing device, a first security activity with the user identifying data to obtain a secured user identifying data of the user;

determining, by the computing device, a first activity instruction based on the secured user identifying data of the user;

determining, by the computing device, i) a first activity string and ii) a second activity string based on the first activity instruction;

instructing, by the computing device, the application executed on the mobile computing device to display the first activity string to the user;

instructing, by the computing device, the application executed on the mobile computing device to generate an activity data entry of the activity;

instructing, by the computing device, the application executed on the mobile computing device to modify the activity data entry of the activity with the second activity string;

receiving, by the computing device, a third activity string from an activity-performing device;
wherein the first activity string has been received by the activity-performing device from the user;

performing, by the computing device, a second security activity with the third activity string and the first activity string;

instructing, by the computing device, the activity-performing device to perform a second activity based on the second security activity and a second activity instruction; and

instructing, by the computing device, the application executed on the mobile computing device to modify the activity data entry of the activity based on the second activity instruction.

2. The method of clause 1, wherein the initial activity data comprises a check data related to a check provided by the user; and wherein the check data comprises a check amount of the check and at least one image of the check from an image acquisition software residing on the mobile computing device.
3. The method of clause 2, wherein the first activity instruction comprises an instruction to cash the check.
4. The method of clause 3, further comprising:

determining, by the computing device, the check for cashing based on the user being a payee of the check.

5. The method of clause 4, further comprising:

transmitting, by the computing device, the first activity string and the second activity string to the application.

6. The method of clause 5, wherein the activity data entry is a check-cashing activity record and the activity performing device is a check-cashing device.
7. The method of clause 6,
wherein the first activity string comprises a token; and
wherein the check-cashing device is configured to receive the token is received, from the user, via at least one of:
   i) a wireless communication between the mobile computing device and the check-cashing device;
   ii) a QR-code scan by the check-cashing device of a QR-code being displayed by the mobile computing device; and
   iii) a Near Field communication between the mobile computing device and the check-cashing device.
      8. The method of clause 7, further comprising:

receiving, by the computing device, at least one biometrical data of the user, wherein the at least one biometrical data of the user comprises at least one facial scan, a fingerprint, or both.

9. The method of clause 8, wherein the second activity comprises dispensing a dispensed amount, wherein the dispensed amount is at least a portion of the check amount.
10. The method of clause 9, further comprising instructing the mobile computing device to present at least one location of at least one activity-performing device.
11. A system comprising:

a computing device configured to execute software instructions that cause the computing device to at least:
receive, from an application executed on a mobile computing device, an activity data for an activity of a user;
   wherein the activity data comprises an initial activity data;
receive, from the mobile computing device, a first user identifying data from the user;
perform a first security activity with the user identifying data to obtain a secured user identifying data of the user;
determine a first activity instruction based on the secured user identifying data of the user;
determine i) a first activity string and ii) a second activity string, based on the first activity instruction;
instruct the application executed on the mobile computing device to display the first activity string to the user;
instruct the application executed on the mobile computing device to generate an activity data entry of the activity;
instruct the application executed on the mobile computing device to modify the activity data entry of the activity with the second activity string;
receive a third activity string from an activity-performing device;
   wherein the first activity string has been received by the activity-performing device from the user;
perform a second security activity with the third activity string and the first activity string;
instruct the activity-performing device to perform a second activity based on the second security activity and a second activity instruction; and
instruct the application executed on the mobile computing device to modify the activity data entry of the activity based on the second activity instruction.
   12. The system of clause 11, wherein the initial activity data comprises a check data related to a check provided by the user, wherein the check data comprises a check amount of the check and at least one image of the check from an image acquisition software residing on the mobile computing device.
   13. The system of clause 12, wherein the first activity instruction comprises the check for cashing.
   14. The system of clause 13, wherein the software instructions cause the computing device to determine the check for cashing based on the user being a payee of the check.
   15. The system of clause 14, wherein the computing device is further configured to transmit the first activity string and the second activity string to the application.
   16. The system of clause 15, wherein the activity data entry is a check-cashing activity record and the activity performing device is a check-cashing device.
   17. The system of clause 16, wherein the first activity string comprises a token, wherein the check-cashing device is configured to receive the token, from the user, via at least one of:

i) a wireless communication between the mobile computing device and the check-cashing device;

ii) a QR-code scan by the check-cashing device of a QR-code being displayed by the mobile computing device; and

iii) a Near Field communication between the mobile computing device and the check-cashing device.

18. The system of clause 17, wherein the computing device is further configured to receive at least one biometrical data of the user, wherein the at least one biometrical data of the user comprises at least one facial scan, a fingerprint, or both.
19. The system of clause 18, wherein the second activity comprises dispensing a dispensed amount, wherein the dispensed amount is at least a portion of the check amount.
20. The system of clause 19, wherein the computing device is further configured to instruct the mobile computing device to present at least one location of at least one activity-performing device.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by a computing device, from an application executed on a mobile computing device, an activity data for an activity of a user;
wherein the activity data comprises an initial activity data;
receiving, by the computing device, from the mobile computing device, a first user identifying data from the user;
performing, by the computing device, a first security activity with the user identifying data to obtain a secured user identifying data of the user;
determining, by the computing device, a first activity instruction based on the secured user identifying data of the user;
determining, by the computing device, i) a first activity string and ii) a second activity string based on the first activity instruction;
instructing, by the computing device, the application executed on the mobile computing device to display the first activity string to the user;
instructing, by the computing device, the application executed on the mobile computing device to generate an activity data entry of the activity;
instructing, by the computing device, the application executed on the mobile computing device to modify the activity data entry of the activity with the second activity string;
receiving, by the computing device, a third activity string from an activity-performing device;
wherein the first activity string has been received by the activity-performing device from the user;
performing, by the computing device, a second security activity with the third activity string and the first activity string;
instructing, by the computing device, the activity-performing device to perform a second activity based on the second security activity and a second activity instruction; and
instructing, by the computing device, the application executed on the mobile computing device to modify the activity data entry of the activity based on the second activity instruction.

2. The method of claim 1, wherein the initial activity data comprises a check data related to a check provided by the user; and
wherein the check data comprises a check amount of the check and at least one image of the check from an image acquisition software residing on the mobile computing device.

3. The method of claim 2, wherein the first activity instruction comprises an instruction to cash the check.

4. The method of claim 3, further comprising:
determining, by the computing device, the check for cashing based on the user being a payee of the check.

5. The method of claim 4, further comprising:
transmitting, by the computing device, the first activity string and the second activity string to the application.

6. The method of claim 5, wherein the activity data entry is a check-cashing activity record and the activity performing device is a check-cashing device.

7. The method of claim 6,
wherein the first activity string comprises a token; and
wherein the check-cashing device is configured to receive the token is received, from the user, via at least one of:
i) a wireless communication between the mobile computing device and the check-cashing device;
ii) a QR-code scan by the check-cashing device of a QR-code being displayed by the mobile computing device; and
iii) a Near Field communication between the mobile computing device and the check-cashing device.

8. The method of claim 7, further comprising:
receiving, by the computing device, at least one biometrical data of the user, wherein the at least one biometrical data of the user comprises at least one facial scan, a fingerprint, or both.

9. The method of claim 8, wherein the second activity comprises dispensing a dispensed amount, wherein the dispensed amount is at least a portion of the check amount.

10. The method of claim 9, further comprising instructing the mobile computing device to present at least one location of at least one activity-performing device.

11. A system comprising:
a computing device configured to execute software instructions that cause the computing device to at least:
receive, from an application executed on a mobile computing device, an activity data for an activity of a user;
wherein the activity data comprises an initial activity data;
receive, from the mobile computing device, a first user identifying data from the user;
perform a first security activity with the user identifying data to obtain a secured user identifying data of the user;
determine a first activity instruction based on the secured user identifying data of the user;
determine i) a first activity string and ii) a second activity string, based on the first activity instruction;
instruct the application executed on the mobile computing device to display the first activity string to the user;
instruct the application executed on the mobile computing device to generate an activity data entry of the activity;
instruct the application executed on the mobile computing device to modify the activity data entry of the activity with the second activity string;
receive a third activity string from an activity-performing device;
wherein the first activity string has been received by the activity-performing device from the user;
perform a second security activity with the third activity string and the first activity string;
instruct the activity-performing device to perform a second activity based on the second security activity and a second activity instruction; and
instruct the application executed on the mobile computing device to modify the activity data entry of the activity based on the second activity instruction.

12. The system of claim 11, wherein the initial activity data comprises a check data related to a check provided by the user, wherein the check data comprises a check amount of the check and at least one image of the check from an image acquisition software residing on the mobile computing device.

13. The system of claim 12, wherein the first activity instruction comprises the check for cashing.

14. The system of claim 13, wherein the software instructions cause the computing device to determine the check for cashing based on the user being a payee of the check.

15. The system of claim 14, wherein the computing device is further configured to transmit the first activity string and the second activity string to the application.

16. The system of claim 15, wherein the activity data entry is a check-cashing activity record and the activity performing device is a check-cashing device.

17. The system of claim 16, wherein the first activity string comprises a token, wherein the check-cashing device is configured to receive the token, from the user, via at least one of:
i) a wireless communication between the mobile computing device and the check-cashing device;
ii) a QR-code scan by the check-cashing device of a QR-code being displayed by the mobile computing device; and
iii) a Near Field communication between the mobile computing device and the check-cashing device.

18. The system of claim 17, wherein the computing device is further configured to receive at least one biometrical data of the user, wherein the at least one biometrical data of the user comprises at least one facial scan, a fingerprint, or both.

19. The system of claim 18, wherein the second activity comprises dispensing a dispensed amount, wherein the dispensed amount is at least a portion of the check amount.

20. The system of claim 19, wherein the computing device is further configured to instruct the mobile computing device to present at least one location of at least one activity-performing device.
